(19) United States
(12) Patent Application Publication
(10) Pub. No.: US 2009/0219913 A1
(43) Pub. Date: Sep. 3, 2009

(54) Communication Device and Method of Controlling Communication Device

(75) Inventor: Yasuhiro Nakamura, Yokohama (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/280,776

(22) PCT Filed: Feb. 22, 2007
(86) PCT No.: PCT/JP2007/053289

§ 371 Date: Nov. 4, 2008

(30) Foreign Application Priority Data
Feb. 27, 2006 (JP) 2006-051294

(51) Int. Cl. H04J 3/00

(52) U.S. Cl. 370/345

(57) ABSTRACT

In a base station device 12 which sequentially stores a part or the whole of packets in physical slots formed for time-division multiplexing to perform radio communications with another communication device, an empty region determination unit 22 compares the maximum storage size of each of the physical slots and the data size of the part or whole of the packet to be stored in the physical slot, and determines whether or not an empty region is formed in the physical slot. When the empty region determination unit 22 determines that an empty region is formed in the physical slot, a packet storage/extraction unit 24 stores a part or the whole of a packet subsequent to the packet, in the empty region.

### TECHNICAL FIELD

The present invention relates to a communication device and a method of controlling the communication device. The present invention particularly relates to a communication device which sequentially stores a part or the whole of a packet in physical slots according to time-division multiplexing to perform radio communication with another communication device, and a method of controlling the communication device.

### BACKGROUND ART

In radio communications using a time-division multiplex system, a radio section between communication devices is divided into multiple time slots, and packets are stored in the respective time slots (hereinafter referred to as “physical slots”) to be transmitted. When completing transmission of one packet, a communication device using this communication system stores a subsequent packet in the next physical slot, and then transmits the subsequent packet. Accordingly, if the boundary of the packets and the boundary of the physical slots do not coincide, an empty region is formed in the physical slot, In this case, the empty region is filled with a predetermined bit string having no relation to transmission data.

In contrast, in general wired communications, no particular limit is imposed on the size of transmission data in a layer 1 (physical layer), whereby the size of a frame of a layer 2 (data link layer) (hereinafter referred to as layer-2 frames) can be determined freely according to the packet size of a layer 3 (network layer). Therefore, unless otherwise specified by a communication standard or the like, the boundary of the packets and the boundary of the layer-2 frames always coincide, whereby no empty region is formed in the layer-2 frame.

FIG. 1 is a diagram showing a packet communication system in a current personal handy-phone system (PHS) using the time-division multiplex system. The size of the physical slot in the layer 1 is determined by the durations of the respective time slots and the bit rate of a used modulation system. The layer-2 frame is in a one-to-one relationship with the physical slot in the layer 1, and also has the same size as that of the physical slot. The layer-2 frame has a configuration including a layer-2 header and an information field, and a part or the whole of the packet is stored in the information field. As shown in the drawing, the size of a packet #1 is larger than the sizes of the information fields in a frame #1 and a frame #2. Accordingly, the packet #1 is divided according to the sizes of the information fields, and the divided pieces of the packet are then stored in the respective information fields of the layer-2 frames. In the drawing, since the third one of the divided data pieces of the packet #1 is smaller than the size of a corresponding information field in a frame #3, an empty region is formed in the frame #3 and in a corresponding physical slot #3. Here, the layer-2 header includes information showing the size of data stored in the information field, a flag showing whether or not the frame includes a boundary of packets, and the like. A receiving-side communication device determines the boundaries of packets in the layer-2 frames sequentially received, on the basis of the information in the layer-2 headers, and thereby reconstructs the packet.

### DISCLOSURE OF THE INVENTION

As described above, in conventional radio packet communications using the time-division multiplex system, an empty region is sometimes formed in a physical slot, which leads to a problem that the transmission efficiency of packets decreases. Additionally, an increase in size of physical slots along with extended durations of time slots, increased bit rates of a modulation system, and the like, leads to a problem that proportions of empty regions in the physical slots increase, so that the transmission efficiency of packets further decreases.

The present invention has been made in view of the conventional problems described above, and has an object of providing a communication device, in which the transmission efficiency is improved without an empty region being formed in a physical slot in a radio communication using the time-division multiplex system, and a method of controlling such a communication device.

In order to achieve the object described above, the present invention provides a communication device which sequentially stores a part or whole of a packet in physical slots according to time-division multiplexing to perform a radio communication with another communication device, the communication device comprising: an empty region determination unit configured to determine whether or not an empty region is formed in the physical slot, on the basis of a result from a comparison between a storage size of each of the physical slots and a data size of a part or whole of the packet to be stored in the physical slot; and a packet storage unit configured to, when the empty region determination unit determines that an empty region is formed in the physical slot, store a part or whole of a subsequent packet of the packet, in the empty region.

A method of controlling a communication device according to the present invention is a method of controlling a communication device which sequentially stores a part or whole of a packet in physical slots according to time-division multiplexing to perform a radio communication with another communication device, the method comprising: an empty region determination step of determining whether or not an empty region is formed in the physical slot, on the basis of a result from a comparison between a storage size of each of the physical slots and a data size of a part or whole of the packet to be stored in the physical slot; and a packet storage step of, when it is determined that an empty region is formed in the physical slot in the empty region determination step, storing a part or whole of a subsequent packet of the packet, in the empty region.

In the present invention, the storage size of the physical slot and the data size of the part or whole of the packet to be stored in the physical slot are compared, and whether or not the empty region is formed in the physical slot is determined on the basis of the comparison result. When it is determined that the empty region is formed, the part or the whole of the packet subsequent to the packet to be stored in the physical slot is stored in the empty region. According to the present invention, no empty region is formed in the physical slot, whereby the transmission efficiency can be improved.

In one aspect of the present invention, further included is a segment information insertion unit configured to insert segment information indicating a boundary of data, into at least a portion between packet parts to be stored in the physical slots, the packet parts each being the part or whole of the corresponding packet. Accordingly, the boundary between packets becomes clear, whereby each of the packets can be easily extracted from the physical slot by the communication device on the receiving side.

In one aspect of the present invention, the segment information insertion unit inserts the segment information between the packets to be stored in the physical slots. Accordingly, even when two or more packets are stored in one physical slot or when one packet is stored in two or more physical slots, the boundary between packets becomes clear, whereby the respective packets can easily be extracted from the physical slot by the communication device on the receiving side.

In one aspect of the present invention, the segment information includes information indicating a data size of a packet subsequent to the segment information. Accordingly, the inserted position of the next segment information can be easily identified on the basis of the information indicating the data size included in the segment information.

In one aspect of the present invention, when the empty region determination unit determines that an empty region is formed in the physical slot, the segment information insertion unit inserts the segment information in front of each of a plurality of the packets to be stored in the physical slot; and the segment information includes information indicating a data size of the packet subsequent to the segment information in the physical slot. Accordingly, when two or more packets are stored in one physical slot, the boundary of portions corresponding to the multiple packets stored in the physical slot becomes clear, whereby each of the packets can easily be extracted from the physical slot by the communication device on the receiving side.

In one aspect of the present invention, a slot size of the physical slot is determined on the basis of a data rate of a modulation system used for the physical slot. Accordingly, even when the slot sizes differ due to different modulation systems employed for each of the physical slots, no empty region is formed in the physical slot, whereby the transmission efficiency can be improved.

### BRIEF DESCRIPTION OF THE DRAWINGS

FIG. 1 is a diagram illustrating a packet communication system which is put into practical use in a current PHS system.

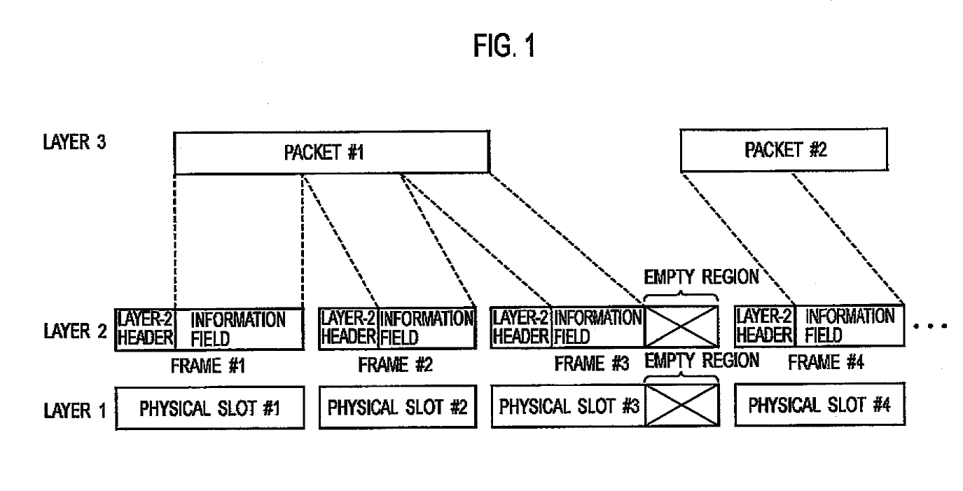

FIG. 2 is a configuration diagram of a mobile communication system according to an embodiment of the present invention.

FIG. 3 is a functional block diagram of a base station device according to an embodiment of the present invention.

FIG. 4 is a diagram illustrating a method of storing a packet in a first embodiment of the present invention.

FIG. 5 is a diagram illustrating a method of storing a packet in a second embodiment of the present invention.

FIG. 6 is a flowchart illustrating steps in which a packet is stored in a physical slot and the stored packet is transmitted in the first embodiment.

FIG. 7 is a flowchart illustrating steps in which a s packet is stored in a physical slot and the stored packet is transmitted in the second embodiment.

### BEST MODES FOR CARRYING OUT THE INVENTION

### First Embodiment

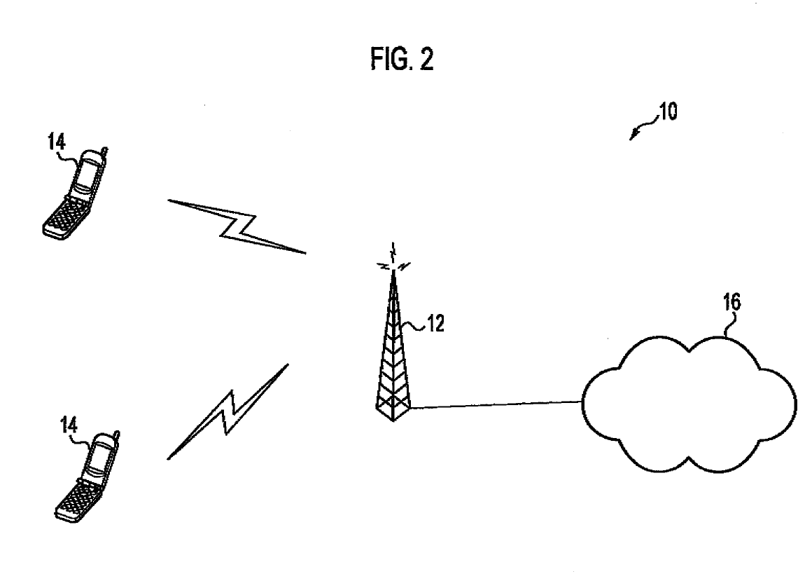

A first embodiment of the present invention will be described below on the basis of the drawings. FIG. 2 is a diagram showing the entire configuration of a mobile communication system 10 according to the embodiment of the present invention. As shown in the drawing, the mobile communication system 10 includes a base station device 12 connected to a communication network 16 through a wired transmission path and multiple mobile station devices 14 connected to the base station device 12 through radio transmission paths.

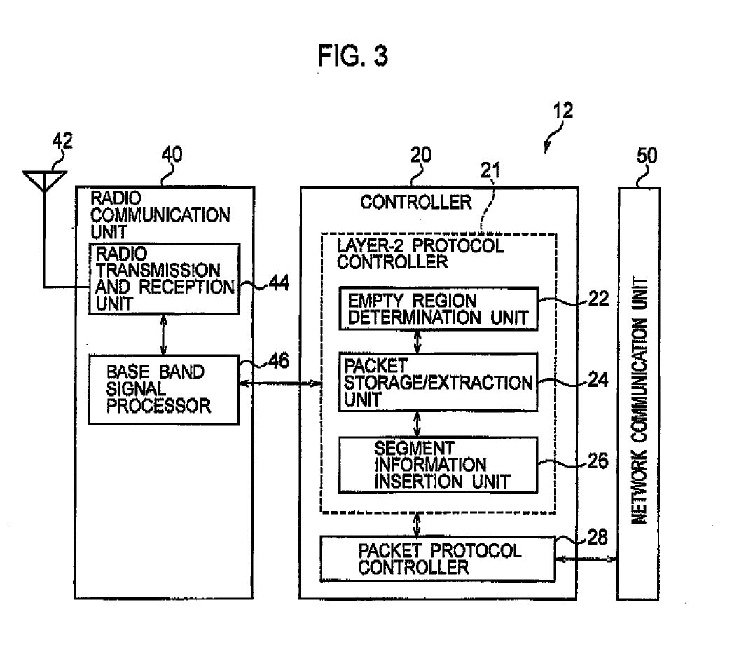

FIG. 3 is a functional block diagram of the base station device 12. The base station device 12 includes a controller 20, a radio communication unit 40, and a network communication unit 50. The base station device 12 transmits radio signals to, and receives radio signals from mobile station devices 14 using a time-division multiple access (TDMA) system, and transmits packets to, and receives packets from the other base station device 12 via the communication network 16, the packets including data according to the radio signals.

A radio transmission channel (radio section) between the base station device 12 and the mobile station device 14 is divided into multiple time slots, and the multiple time slots respectively correspond to physical slots in a layer 1. The physical slots each are determined on the basis of the duration of the corresponding time slot and the bit rate of the modulation system employed in the time slot. Therefore, even if the durations of time slots are the same, the sizes of the physical slots may be different if the modulation systems for the corresponding time slots differ from each other.

In the time-division multiplexing, the physical slot is in one-to-one relationship with layer-2 frame, and the size of the physical slot is the same as that of the layer-2 frame. Therefore, the entire layer-2 frame is stored in the corresponding physical slot in just proportion. The layer-2 frame also includes the layer-2 header and the information field, and the information field stores a part or whole of a packet in a layer 3. In this manner, the base station device 12 sequentially stores the part or whole of the packets in the physical slots formed for the time-division multiplexing to transmit radio signals to, and receive radio signals from the mobile station device 14.

The radio communication unit 40 includes an antenna 42, a radio transmission and reception unit 44, and a base band signal processor 46. The antenna 42 is connected to the radio transmission and reception unit 44. The radio transmission and reception unit 44 includes a transmitter and a receiver. The radio transmission and reception unit 44 switches an access point of the antenna 42 to and from between the transmitter and the receipt at predetermined time intervals.

The transmitter of the radio transmission and reception unit 44 includes an up-converter, a power amplifier, and the like. The transmitter converts a base band signal inputted from the base band signal processor 46 into a transmission signal, amplifies the signal up to a transmission output level, and outputs the signal to the antenna 42.

The receiver of the radio transmission and reception unit 44 includes a low-noise amplifier, a down-converter, and the like. The receiver converts a reception signal received by the antenna 42 into a base band signal, amplifies the signal, and outputs the signal to the base band signal processor 46.

The base band signal processor 46 converts transmission data inputted from the network communication unit 50 via the controller 20 into a base band signal and outputs the signal to the radio transmission and reception unit 44 So that the signal can be transmitted to a desired mobile station device 14. The base band signal processor 46 also converts a base band signal from the mobile station device 14 which is inputted from the radio transmission and reception unit 44 into reception data and outputs the signal to the network communication unit via the controller 20.

The network communication unit 50 is connected to the communication network 16 via a wired transmission path such as an ISDN line. The network communication unit 50 is also connected with a packet protocol controller 28 of the controller 20 to be described later, and exchanges multiple packets between communication lines and the packet protocol unit 28.

The controller 20 includes a layer-2 protocol controller 21 and the packet protocol controller 28, and performs control of the entire base station device 12. The controller 20 includes a CPU, a memory, and the like.

The packet protocol controller 28 is connected with the layer-2 protocol controller 21 and the network communication unit 50. The packet protocol controller 28 adds a predetermined layer-3 header or the like to a packet inputted from the layer-2 protocol controller 21, and outputs the resultant packet to the network communication unit 50. The packet protocol controller 28 also extracts a packet from data inputted from the network communication unit 50, and outputs the resultant packet to the layer-2 protocol controller 21.

The layer-2 protocol controller 21 includes an empty region determination unit 22, a packet storage/extraction unit 24, and a segment information insertion unit 26. The layer-2 protocol controller 21 is connected with the packet protocol controller 28 and the base band Signal processor 46.

In order to generate the layer-2 frame, the layer-2 protocol controller 21 adds the predetermined layer-2 header to data in which packets sequentially inputted from the packet protocol controller 28 are divided, coupled, or performed other operations as necessary. Then the layer-2 protocol controller 21 outputs the layer-2 frame thus generated to the base band signal processor 46. The layer-2 protocol controller 21 extracts packets sequentially from the layer-2 frame inputted from the base band signal processor 46 and outputs the extracted packets to the packet protocol controller 28.

The empty region determination unit 22 compares the maximum storage size of the physical slot and the data size of a part or whole of the packet to be stored in the physical slot, and determines whether or not an empty region is formed in the physical slot on the basis of the comparison results. In this embodiment, the frame size of the layer-2 frame and the slot size of the physical slot is the same, whereby the presence or absence of the empty region is determined by using the maximum storage size of the layer-2 frame instead of the maximum storage size of the physical slot.

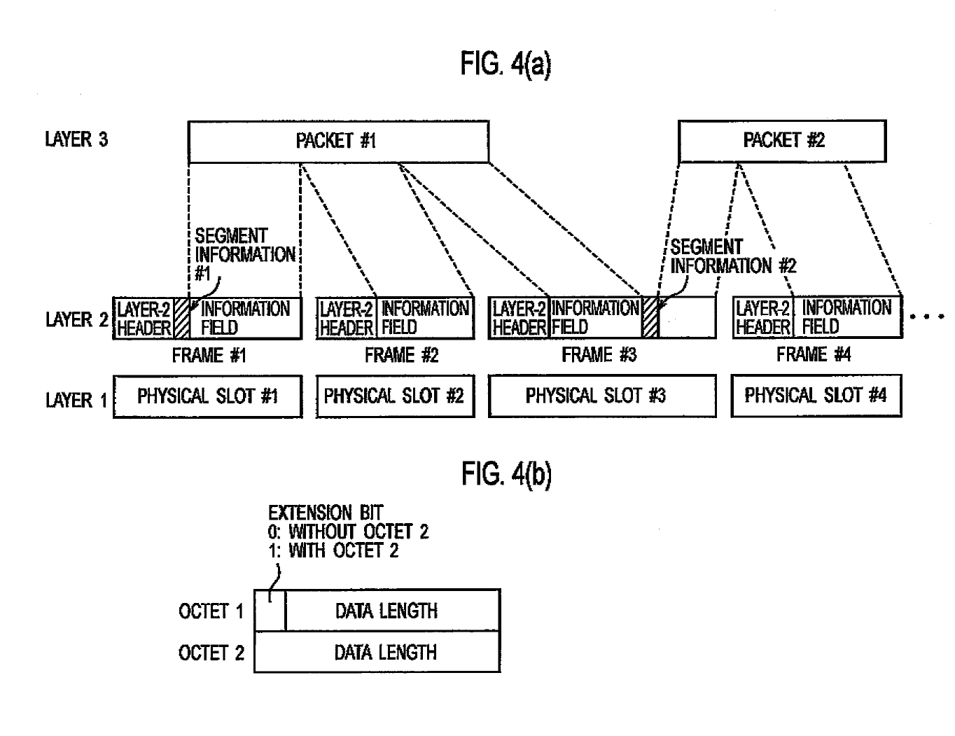

FIG. 4 is a diagram illustrating a method of storing a packet in the first embodiment. As shown in FIG. 4 (a), the size of a packet #1 is larger than the maximum storage size (size of the information field) of a corresponding frame #1. Therefore, the packet #1 is divided according to the sizes of the respective information fields by the packet storage/extraction unit 24 to be described later, and stored in the respective information fields.

In FIG. 4(a), first and second divided data pieces of the packet #1 are respectively stored in the information fields of the corresponding frame #1 and frame #2 in just proportion. However, the size of a third divided data piece of the packet #1 is smaller than the maximum storage size (sizes of the information field) of a corresponding frame #3. Therefore, an empty region is formed in the frame #3. In such case, the empty region determination unit 22 determines that the empty region is formed in a physical slot #3 (frame #3) corresponding to the third divided data piece.

The packet storage/extraction unit 24 divides/couples packets according to the maximum storage sizes of the respective physical slots, and stores the part or whole of the packets in the physical slots, When the empty region determination unit 22 has determined that an empty region is formed in the target physical slot, a part or whole of a packet subsequent to the packet is stored in the empty region. In this embodiment, the size of the layer-2 frame and that of the physical slot are the same, whereby a part or whole of the packet is stored in the information field in the layer-2 frame according to the maximum storage size (sizes of the information field) in the layer-2 frame.

As described above, in an example shown in FIG. 4 (a), since the empty region determination unit 22 determines that the empty region is formed in the physical slot #3 (frame #3), the packet storage/extraction unit 24 divides a packet #2, which is the packet subsequent to the packet #1, according to the size of the empty region. Furthermore, the packet storage/extraction unit 24 stores the divided data piece of the subsequent packet in the empty region of the frame #3 in just proportion.

Accordingly, no empty region is formed in the frame #3, whereby an empty region is not formed either in the physical slot #3. Note that the layer-2 header may store auxiliary information which is used when a device on the receiving side extracts a packet from the layer-2 frame. Accordingly, when the base station device 12 receives a radio signal from the mobile station device 14, the packet storage/extraction unit 24 can extract a packet on the basis of the layer-2 header and the information field which are inputted from the base band signal processor 46.

The segment information insertion unit 26 inserts segment information, which shows a boundary of packets, between the packets stored in the respective physical slots. In the example shown in FIG. 4(a), the segment information insertion unit 26 inserts segment information #2 in the frame #3 between the packet #1 and the packet #2, the frame #3 simultaneously storing the packet #1 and the packet #2. The segment information insertion unit 26 also inserts segment information #1 at the front portion of the packet #1 which is transmitted first immediately after the start of communication. Note that each of the pieces of the segment information may include predetermined bit strings for identifying boundaries of packets.

Accordingly, even when two or more packets are stored in one layer-2 frame or when one packet is stored in two or more layer-2 frames, the boundary between packets is made clear. Therefore, a communication device on the receiving side can easily extract each packet from the physical slots. In other words, by taking out data between pieces of the segment information as one unit, the packet can be easily extracted

Each of the pieces of the segment information may include information showing the data size for a packet subsequent to the segment information. Accordingly, the inserted position of the next segment information can easily be identified on the basis of the information showing the data size included in the segment information.

FIG. 4(b) shows an example of a format of the segment information. As shown in the drawing, the segment information has an extension bit (first bit of a first octet) and a data length. When the data length is within 0 to 127 octets, 1 octet is sufficient as the size of the Segment information, whereby the extension bit is set too to show that the Size of the segment information is 1 octet. On the other hand, when the data length is within 128 to 32767 octets, 2 octets are required as the size of the segment information, whereby the extension bit is set to 1 to show that the size of the segment information is 2 octets.

In the example shown in FIG. 4(a), the data length of the segment information #1 includes information showing the size of the packet #1. The data length of the segment information #2 includes information showing the size of the packet #2. Accordingly, the communication device on the receiving side can easily identify that data having the segment information #1 as a starting point and a data length shown by the segment information #1 is the packet #1, and that data subsequent to the packet #1 is the segment information #2.

As described above, the insertion, made by the segment information insertion unit 26, of the segment information showing the boundary of packets between the packets to be stored in the physical slots allows the packet storage/extraction unit 24 in the communication device on the receiving side to easily extract the packet on the basis of the segment information.

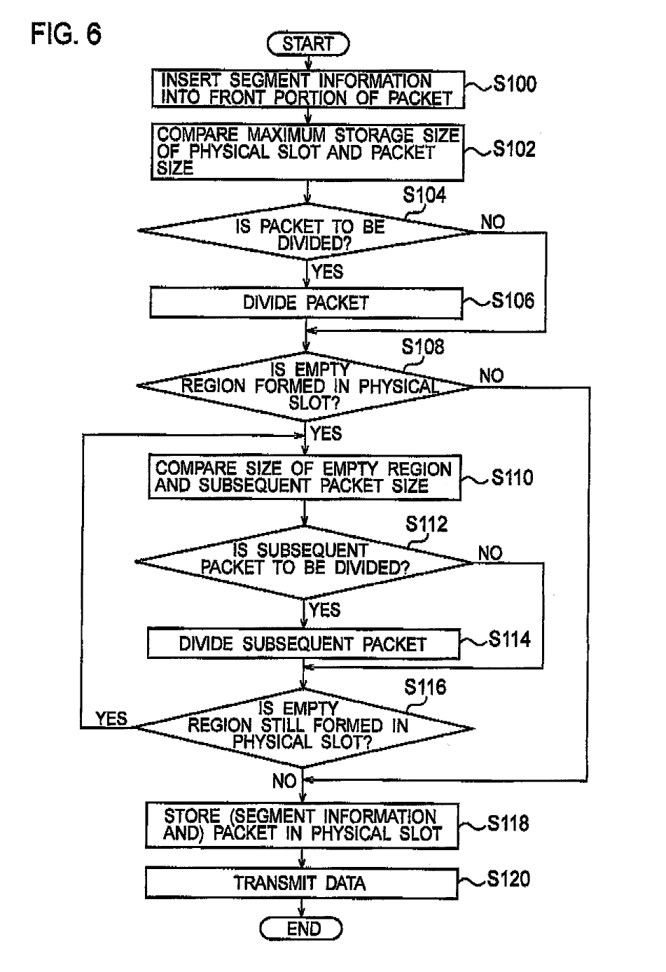

Next, steps in which the base station device 12 stores a packet in the physical slot and transmits the packet in this embodiment will be described on the basis of a flowchart of FIG. 6. Herein, it is assumed that the packet protocol controller 28 extracts packets from data inputted from the network communication unit 50, and sequentially outputs the extracted packets to the layer-2 protocol controller 21.

When the layer-2 protocol controller 21 receives the packet from the packet protocol controller 28, the segment information insertion unit 26 inserts the segment information including the size of the packet at the front portion of the packet (S100).

The packet storage/extraction unit 24 compares the maximum storage size of the physical slot which stores a packet and the size of the packet (S102). Specifically, the packet storage/extraction unit 24 compares the maximum storage size of the information field in the layer-2 frame corresponding to the physical slot and the size of the packet (including the size of the segment information inserted in S100).

When the packet size is larger than the maximum storage size of the information field, the packet storage/extraction unit 24 determines that the packet needs to be divided in S104. The packet storage/extraction unit 24 divides the packet (including the segment information) at a position rearward from the front portion by the maximum storage size of the information field (S106). When the packet is divided in this manner, the maximum storage size of the information field and the size of the front portion of the divided packet thus obtained become the same. Therefore, no empty region is formed in the information field of the frame-2 layer. Thus, the empty region determination unit 22 determines that no empty region is formed either in the corresponding physical slot.

When the packet size (including the segment information) is smaller than or equal to the maximum storage size of the information field, the packet storage/extraction unit 24 determines in S104 that dividing the packet is unnecessary, and proceeds to S108.

When the empty region determination unit 22 determines in S108 that no empty region is formed in the physical slot, the packet storage/extraction unit 24 stores the front portion (including the size of the segment information) of the packet divided in S106 in the information field to generate the layer-2 frame without an empty region.

The layer-2 protocol controller 21 outputs the layer-2 frame to the base band signal processor 46. The base band signal processor 46 generates a base band signal according to the layer-2 frame. The radio transmission and reception unit 44 converts the base band signal into a transmission signal, stores the transmission signal in a corresponding physical slot (S118), and transmits the signal (S120).

On the other hand, when the empty region determination unit 22 determines in S108 that an empty region is formed in the physical slot, i.e., when the size of the packet (including the size of the segment information) is smaller than the maximum storage size of the information field, the packet storage/extraction unit 24 compares the size of the empty region, which is formed after the packet is stored in the information field, and the size of a packet (including the size of the segment information inserted in S100) subsequent to the packet (S110).

When the size of the subsequent packet is larger than the size of the empty region as a result of the comparison, the packet storage/extraction unit 24 determines in S112 that the subsequent packet needs to be divided, and divides the subsequent packet (including the segment information) at a position rearward from the front portion by the size of the empty region (S114). When the packet is divided in this manner, the size of the empty region and the size of the front portion of the divided subsequent packet thus obtained become the same. Therefore, no empty region is formed in the information field of the frame-2 layer. Thus, the empty region determination unit 22 determines that an empty region is not formed either in the corresponding physical slot.

When the size (including the segment information) of the subsequent packet is smaller than or equal to the size of the empty region, the packet storage/extraction unit 24 determines in S112 that dividing the subsequent packet is unnecessary, and proceeds to S116. Note that, when it is determined in S116 that an empty region is still formed even after the packet subsequent to the packet is stored, the steps of S110 to S116 described above are further performed for a packet subsequent to the subsequent packet.

When the empty region determination unit 22 determines in S116 that no empty region is formed in the physical slot, the packet storage/extraction unit 24 stores the segment information and corresponding portions of the multiple packets in the information field to generate the layer-2 frame. The radio transmission and reception unit 44 stores a transmission signal corresponding to the layer-2 frame in the corresponding physical slot and transmits the signal in the steps of S118 to S120 described abode.

### Second Embodiment

Next, a second embodiment of the present invention will be described on the basis of the drawings. Note that descriptions will be omitted for the same portions as those of the first embodiment.

The system configuration of the mobile communication system 10 and the functional block configuration of the base station device of this embodiment are respectively the same as those of FIGS. 2 and 3 shown in the first embodiment. The segment information insertion unit 26 being different from that of the first embodiment will be described below.

When the empty region determination unit 22 determines that an empty region is formed in the physical slot, the segment information insertion unit 26 inserts the segment information in front of the multiple packets to be stored in the physical slots. The segment information includes information showing the data size of a packet subsequent to the segment information within the physical slot. Therefore, when two or more packets are stored in one physical slot, the boundary of corresponding portions of the multiple packets stored in the physical slot becomes clear, whereby each of the portions can easily be extracted.

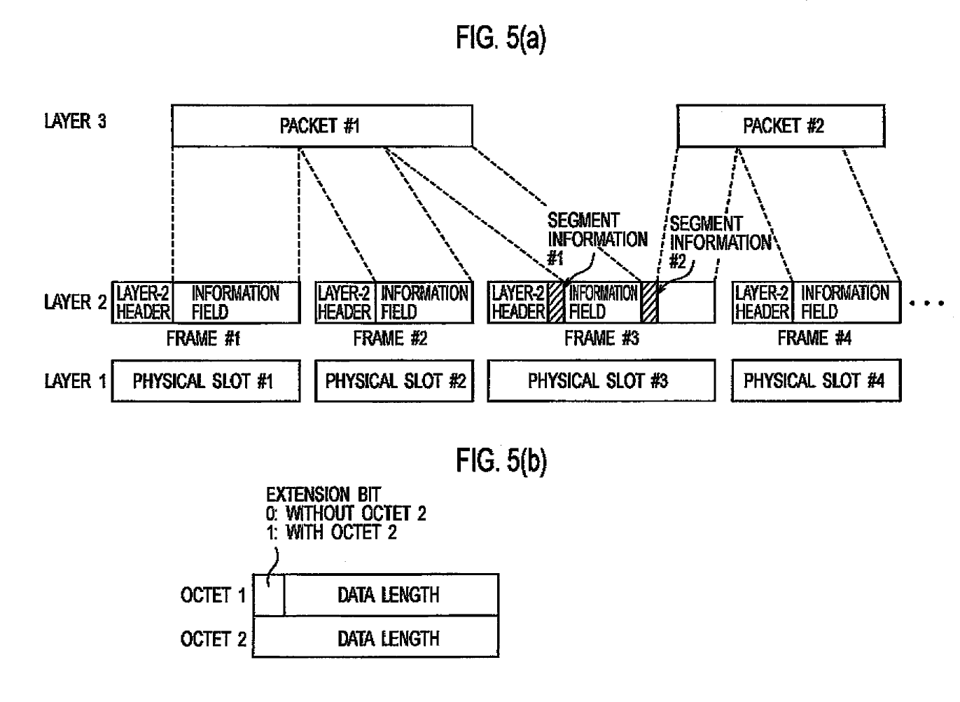

FIG. 5 is a diagram illustrating a method of storing a packet of the second embodiment. In an example shown in FIG. 5(a), the empty region determination unit 22 determines that an empty region is formed in the frame #3, and the packet storage/extraction unit 24 stores portions corresponding to the packet #1 and the packet #2 in the frame #3.

In this case, in front of the portion corresponding to the packet #1 in the frame #3, the segment information insertion unit 26 inserts the segment information including the data size of the portion corresponding thereto. In the same manner, in front of the portion corresponding to the packet #2, the segment information insertion unit 26 inserts the segment information including the data size of the portion corresponding thereto.

FIG. 5(b) shows an example of a format of the segment information. As shown in the drawing, the segment information has an extension bit (first bit of the first octet) and a data length. When the data length is within 0 to 127 octets, 1 octet is sufficient as the size of the segment information, whereby the extension bit is set to 0 to show that the size of the segment information is 1 octet. On the other hand, when the data length is within 128 to 32767 octets, 2 octets are required as the size of the segment information, whereby the extension bit is set to 1 to show that the size of the segment information is 2 octets.

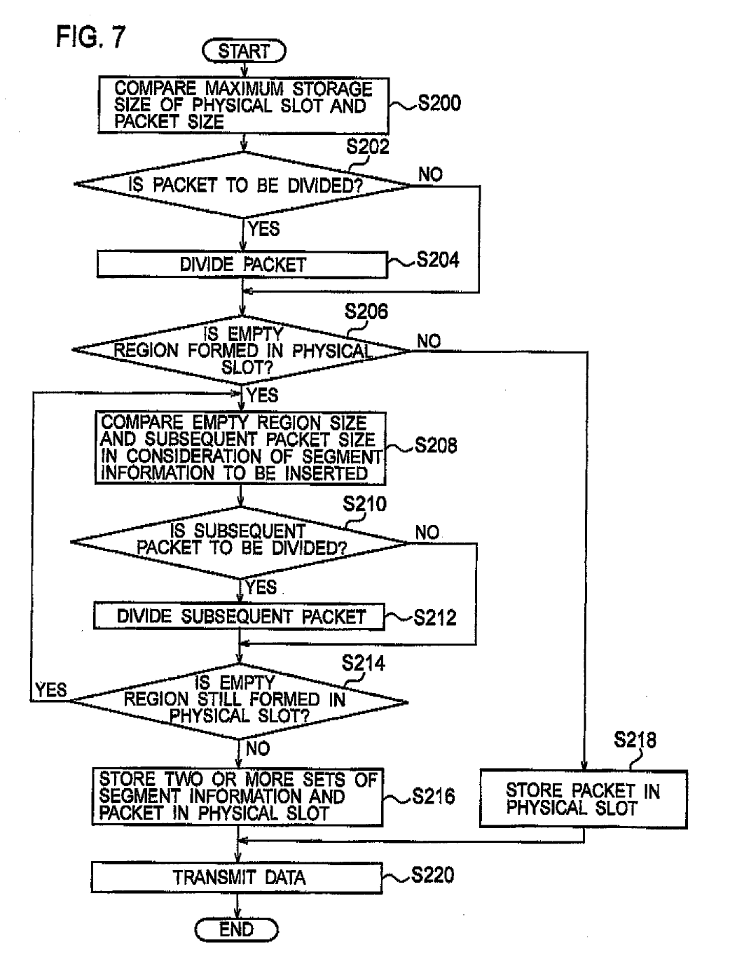

Next, a step in which the base station device 12 stores a packet in the physical slot and transmits the packet in this embodiment will be described on the basis of a flowchart of FIG. 7. Herein, it is assumed that the packet protocol controller 28 extracts packets from data inputted by the network communication unit 50, and sequentially outputs the extracted packets to the layer-2 protocol controller 21.

When the layer-2 protocol controller 21 receives the packet from the packet protocol controller 28, the packet storage/extraction unit 24 compares the maximum storage size of the physical slot which stores the packet and the size of the packet (S200). Specifically, the packet storage/extraction unit 24 compares the maximum storage size of the information field of the layer-2 frame corresponding to the physical slot and the size of the packet.

When the packet size is larger than the maximum storage size of the information field, the packet storage/extraction unit 24 determines in S202 that the packet needs to be divided. The packet storage/extraction unit 24 divides the packet at a position rearward from the front portion by the maximum storage size of the information field (S204). When the packet is divided in this manner, the maximum storage size of the information field and the size of the front portion of the divided packet thus obtained become the same. Therefore, no empty region is formed in the information field of the frame-2 layer. Thus, the empty region determination unit 22 determines that no empty region is formed either in the corresponding physical slot.

When the packet size is smaller than or equal to the maximum storage size of the information field, the packet storage/extraction unit 24 determines in S202 that dividing the packet is unnecessary, and proceeds to S206.

When the empty region determination unit 22 determines in S206 that no empty region is formed in the physical slot, the packet storage/extraction unit 24 stores the front portion of the packet divided in S204 in the information field to generate the layer-2 frame without an empty region.

The layer-2 protocol controller 21 outputs the layer-2 frame to the base band signal processor 46. The base band signal processor 46 generates a base band signal according to the layer-2 frame. The radio transmission and reception unit 44 converts the base band signal into a transmission signal, stores the transmission signal in a corresponding physical slot (S218), and transmits the signal (S220).

On the other hand, when the empty region determination unit 22 determines in S206 that an empty region is formed in the physical slot, i.e., when the size of the packet is smaller than the maximum storage size of the information field, the packet storage/extraction unit 24 compares the size of the empty region, which is formed after the packet and the segment information to be inserted in front of the packet are stored in the information field, and the size of a packet (including the segment information inserted in front of the subsequent packet) subsequent to the packet (S208).

When the size of the subsequent packet (including the segment information) is larger than the size of the empty region as a result of the comparison, the packet storage/extraction unit 24 determines in S210 that the subsequent packet needs to be divided, and divides the subsequent packet (including the segment information) at a position rearward from the front portion by the size of the empty region (S212). When the packet is divided in this manner, the size of the empty region and the size of the front portion (including the segment information) of the divided subsequent packet thus obtained become the same. Therefore, no empty region is formed in the information field of the frame-2 layer. Thus, the empty region determination unit 22 determines that no empty region is formed either in the corresponding physical slot.

When the size of the subsequent packet (including the segment information) is smaller than or equal to the size of the empty region, the packet storage/extraction unit 24 determines in S214 that dividing the subsequent packet is unnecessary, and proceeds to S216. Note that, when it is determined in S214 that an empty region is still formed even after the packet subsequent to the packet is stored, the steps of S208 to S214 described above are further performed for a packet subsequent to the subsequent packet.

When the empty region determination unit 22 determines in S214 that no empty region is formed in the physical slot, the segment information insertion unit 26 inserts the segment information including the data size of each subsequent portion in front of the corresponding portion of the each packet.

The packet storage/extraction unit 24 stores the multiple segment information pieces and the corresponding portions of the multiple packets in the information field to generate the layer-2 frame. The layer-2 protocol controller 21 outputs the layer-2 frame to the base band signal processor 46.

The base band signal processor 46 generates a base band signal according to the layer-2 frame. The radio transmission and reception unit 44 converts the base band signal into a transmission signal, stores the transmission signal in a corresponding physical slot (S216), and transmits the signal (S220).

According to a communication device and a method of controlling a communication device described above, the transmission efficiency can be improved without an empty region being formed in a physical slot in a radio communication using time-division multiplex system.

Note that the present invention is not limited to the embodiments described above. For example, the present invention can be applied to not only a mobile communication system including multiple base station devices and multiple mobile station devices but also any communication device which performs radio communication using time-division multiplexing.

Note that Japanese Patent Application No. 2006-051294 (filed on Feb. 27, 2006) is incorporated herein by reference in its entirety.

### INDUSTRIAL APPLICABILITY

As described above, a communication device and a method of controlling a communication device according to the present a invention are useful in radio communications Such as a mobile communication, since the transmission efficiency can be improved without an empty region being formed in a physical slot in a radio communication using a time-division multiplex system.

1. A communication device which sequentially stores a part or whole of a packet in physical slots according to s time-division multiplexing to perform a radio communication with another communication device, the communication device comprising:
an empty region determination unit configured to determine whether or not an empty region is formed in the physical slot, on the basis of a result from a comparison between a storage size of each of the physical slots and a data size of a part or whole of the packet to be stored in the physical slot; and
a packet storage unit configured to, when the empty region determination unit determines that an empty region is formed in the physical slot, store a part or whole of a subsequent packet of the packet, in the empty region.

2. The communication device according to claim 1, further comprising a segment information insertion unit configured to insert segment information indicating a boundary of data, into at least a portion between packet parts to be stored in the physical slots, the packet parts each being the part or whole of the packet.

3. The communication device according to claim 2, wherein the segment information insertion unit inserts the segment information between packets to be stored in each of physical slots.

4. The communication device according to claim 3, wherein the segment information includes information indicating a data size related with a packet subsequent to the segment information.

5. The communication device according to claim 2 wherein
when the empty region determination unit determines that an empty region is formed in the physical slot, the segment information insertion unit inserts the segment information in front of each of a plurality of packets to be stored in the physical slot; and
the segment information includes information indicating a data size of a packet subsequent to the segment information in the physical slot.

6. The communication device according to any one of claims 1 to 5, wherein a slot size of each of the physical slots is determined on the basis of a data rate of a modulation system used for the physical slot.

7. A method of controlling a communication device which sequentially stores a part or whole of a packet in physical slots according to time-division multiplexing to perform a radio communication with another communication device, the method comprising;
an empty region determination step of determining whether or not an empty region is formed in the physical slot, on the basis of a result from a comparison between a storage size of each of the physical slots and a data size of a part or whole of the packet to be stored in the physical slot; and
a packet storage step of, when it is determined that an empty region is formed in the physical slot in the empty region determination step, storing a part or whole of a subsequent packet of the packet, in the empty region.
